(19) United States
(12) Patent Application Publication
(10) Pub. No.: US 2007/0215721 A1
(43) Pub. Date: Sep. 20, 2007

(54) Spray gun

(76) Inventors: Alfred Gohring, Salem (DE); Herman Probst, Ravensburg (DE); Elmar Krayer, Langenargen (DE); Jens Ulbrich, Friedrichshafen (DE)

Correspondence Address: Pandiscio & Pandiscio, 470 Totten Pond Road, Waltham, MA, 02451-1914, US

(21) Appl. No.: 11/702,855

(22) Filed: Feb. 6, 2007

(30) Foreign Application Priority Data
Feb. 11, 2006 (EP) 06002791

(51) Int. Cl. A62C 13/62

(52) U.S. Cl. 239/340

(57) ABSTRACT

In a spray gun (1) for spraying paint or similar viscous media with a gun housing (2) provided with a handle (3), to which a reservoir tank (21) is removably attached, the reservoir tank (21) is configured as a storage container (22) that is adapted and adjusted to the spray gun (1), for example in the form of a paint can or a paint bag. Furthermore, the storage container (22) is directly secured to a projection (11) of the gun housing (2).

This embodiment makes it possible for special storage containers (22), although differing considerably in their shape and dimensions, to be fitted onto the gun housing (2) in a very straightforward manner and in a short time, in which case the storage container can contain a medium that is intended for immediate processing. Viscosity settings are therefore no longer necessary, while the medium can also be matched to the particular working implement and the application. Also, there is no need for transferring media from one container to another and/or for the associated cleaning work.

The present invention relates to a spray gun for spraying paints and similar viscous media that can be propelled pneumatically or electrically, comprising a gun housing for accommodating the propulsion mechanism, the components of the spray gun that effect mixture and/or metering, a handle projecting from the gun housing and a reservoir tank removably attached to the gun housing for holding the medium to be processed, with the possibility of introducing the medium from the reservoir tank into the gun housing of the spray gun via a feed duct that, in a preferred embodiment, is provided with a riser pipe.

Spray guns of this type have been described in numerous different configurations and have also proven their effectiveness in practice. In order to enable a medium to be processed with these spray guns, it is necessary to remove the reservoir tank from the gun housing and to fill it accordingly. This procedure is time-consuming, and also the paint or other medium can easily be spilled. Furthermore, it is often essential to carry out extensive cleaning work when changing the medium to be processed, and this also takes time. However, the principal disadvantage of these spray guns is that the viscosity of the medium put into the reservoir tank has to be adapted to the particular design configurations of the spraying device by means of which the medium is to be sprayed. This requires expert knowledge and skill. Frequently, it is not possible to achieve an optimum working method with spray guns of prior art.

The purpose of the present invention is therefore to create a spray gun of the aforementioned type that enables reservoir tanks of different configurations to be reliably attached to it straightforwardly and within a short period of time, these tanks being filled with a medium that is adapted to the spray gun to be used and/or the work to be undertaken, meaning that it is possible to process the material immediately after the reservoir tank has been attached to the gun housing. Accordingly, setup times should be practically eliminated and also it should not be necessary to undertake any cleaning work; instead, it should be possible simply to remove one reservoir tank after a working step and to seal it.

In accordance with the present invention, this is achieved in a spray gun of the aforementioned type in that the reservoir tank is configured as a storage container that is adapted to the spray gun and adjusted to it, in particular in the form of a special paint can or paint bag and that the storage container is attached directly to a projection that is preferably configured as a cover or plate that is connected to the gun housing and/or to the handle by a web, or can be attached to the projection by means of clamping elements supported against the projection.

In a simple embodiment, the storage container can be configured in the form of a metallic paint can and it can be screwed directly into a female thread provided in the projection by means of a thread on the edge area of the can facing the can opening.

According to a different embodiment, the end area of the storage container facing the projection can be provided with a radially projecting collar, the projection can have a female thread, and a clamping element configured as a clamping ring can be provided for clamping the storage container onto the projection, with the possibility of pressing this clamping element against the projection and/or a seal inserted in it, either directly or by means of clamping arms projecting radially inwards acting on the collar.

The clamping element provided for clamping the storage container can also be configured as a hollow body for accommodating the storage container.

In accordance with a further embodiment, provision is made for the storage container to have a riser pipe, preferably arranged centrally and inserted in a recess formed in the base of the storage container, this riser pipe being directly formed onto the closing cap of the storage container and into which the riser pipe of the spray gun can be inserted when the storage container is connected, in which case the storage container should be provided with one or more mixing bodies loosely inserted into it.

In order to compensate for the differing heights of storage containers, it is appropriate for one or more clip-on legs to be provided on these, by means of which the support surface of the storage container can be adapted to the support surface of the handle, although it is also possible to adjust the height of the storage container to the support surface of the handle or to make it possible to change the position of the handle so that the support surfaces of the storage container and of the handle run in one plane.

In accordance with another embodiment, the reservoir tank can be composed of a flexibly deformable bag made from an elastic synthetic material as the storage container that is provided with a sturdy flat termination flange at its end facing the projection of the gun housing, and the bag should be inserted in a support element that can be screwed into a female thread provided in the projection by means of a male thread provided in the upper end area of the support element, with the possibility of clamping a projecting edge of the terminating flange in between the support element and the projection.

In a spray gun actuated by compressed air, it is appropriate for the interior of the bag and/or the space between the support element and the bag to be connected by separate ducts to the air guidance duct in the gun housing of the spray gun, so that the air pressure that builds up supplies the medium to be processed to the gun housing.

Furthermore, it is advantageous for the length of the riser pipe to be adapted to the height of the storage container, for example by means of projections or intermediate pieces, and for each storage container to be supported on the projection by a plate-shaped seal that should be provided with at least one circumferential sealing lip protruding in the direction of the storage container and which should make contact internally against the edge of the opening of the storage container.

If a spray gun is configured in accordance with the present invention, it is possible for commercially available storage containers of widely different shapes and dimensions to be attached straightforwardly and in a very short time to the gun housing, in which case these containers can contain a medium that is ready for immediate processing. Preparatory measures such as adjusting the viscosity are consequently no longer required, rather the medium to be processed can be optimally adapted to the particular working implement and application during the manufacture of a paint.

Furthermore, it is beneficial that, if the spray gun configured in accordance with the present invention is used, there will be scarcely and need for transferring the medium to be processed from one container to another or any need for cleaning work. This is because the storage container can easily be removed from the gun housing following completion of a working procedure and, if necessary, sealed with the original cap or disposed of. This means there are hardly any setup times. By offering straightforward handling in this manner, the processing of media with different consistencies is facilitated to a considerable extent without requiring additional work.

The drawing shows a spray gun configured in accordance with the present invention, with variously configured reservoir tanks attached to it, some of which are attached in different manners. In the drawing,

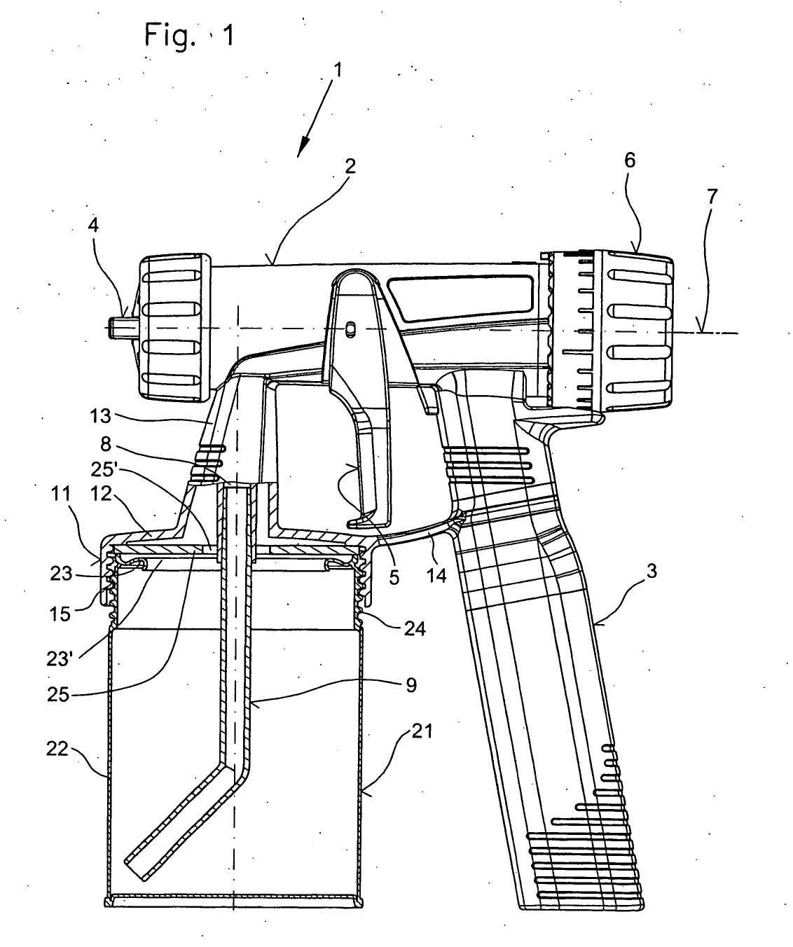

FIG. 1 shows a view of the spray gun in a partial section with a storage container screwed onto it as a reservoir tank,

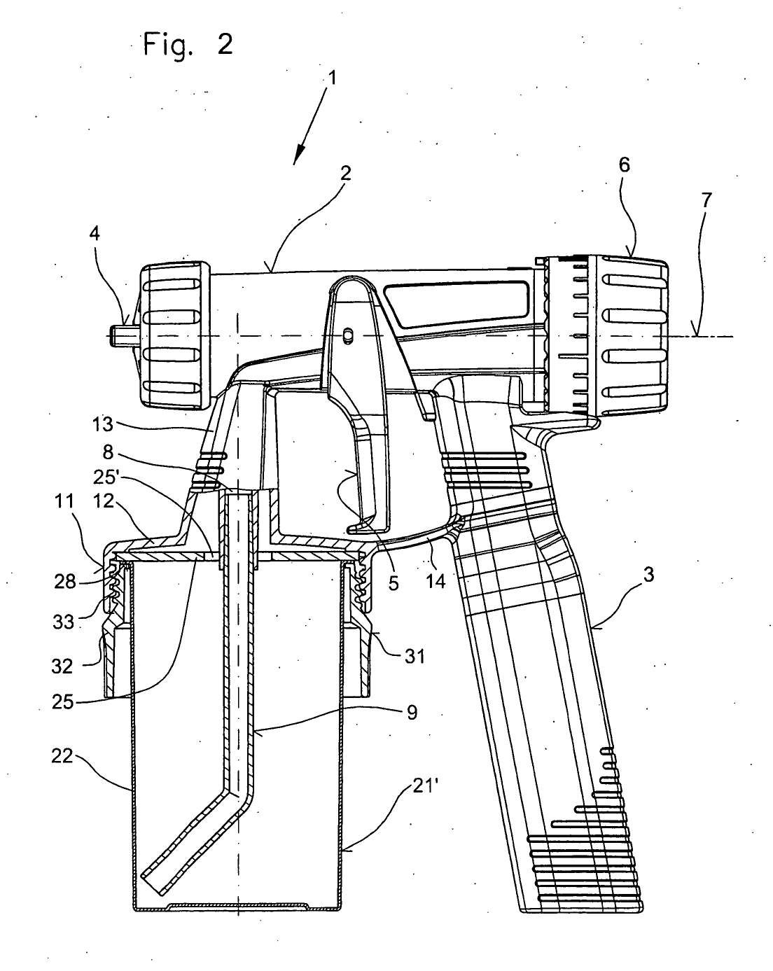

FIG. 2 shows the spray gun in accordance with FIG. 1 with a storage container attached to it by a clamping ring,

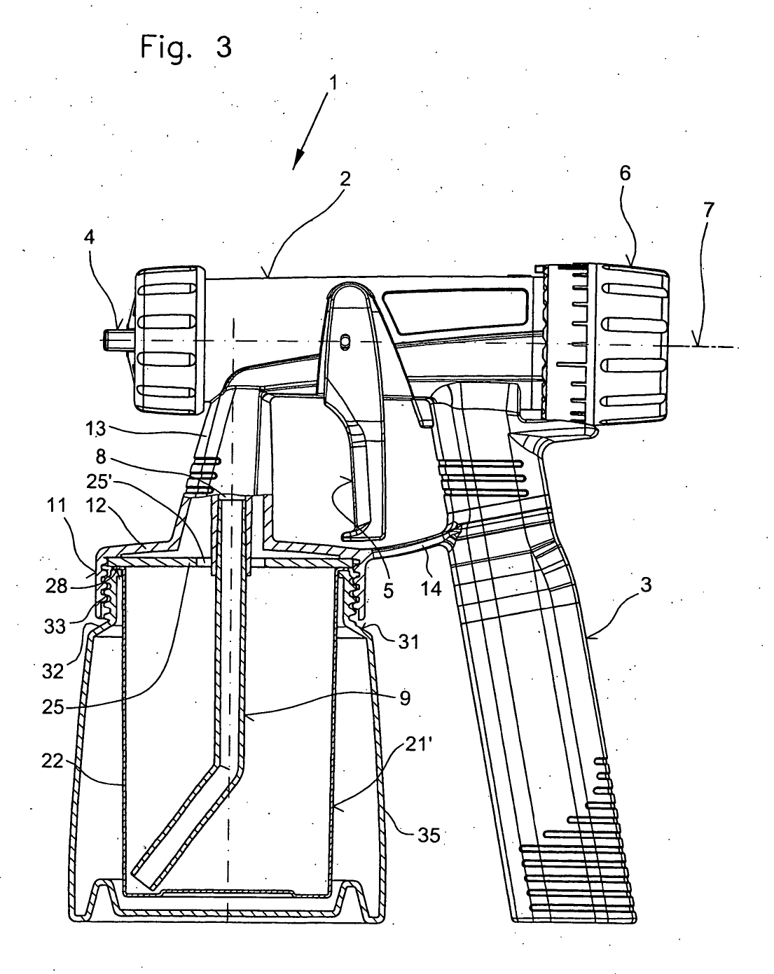

FIG. 3 shows the spray gun in accordance with FIG. 1 with a storage container inserted into a special hollow body,

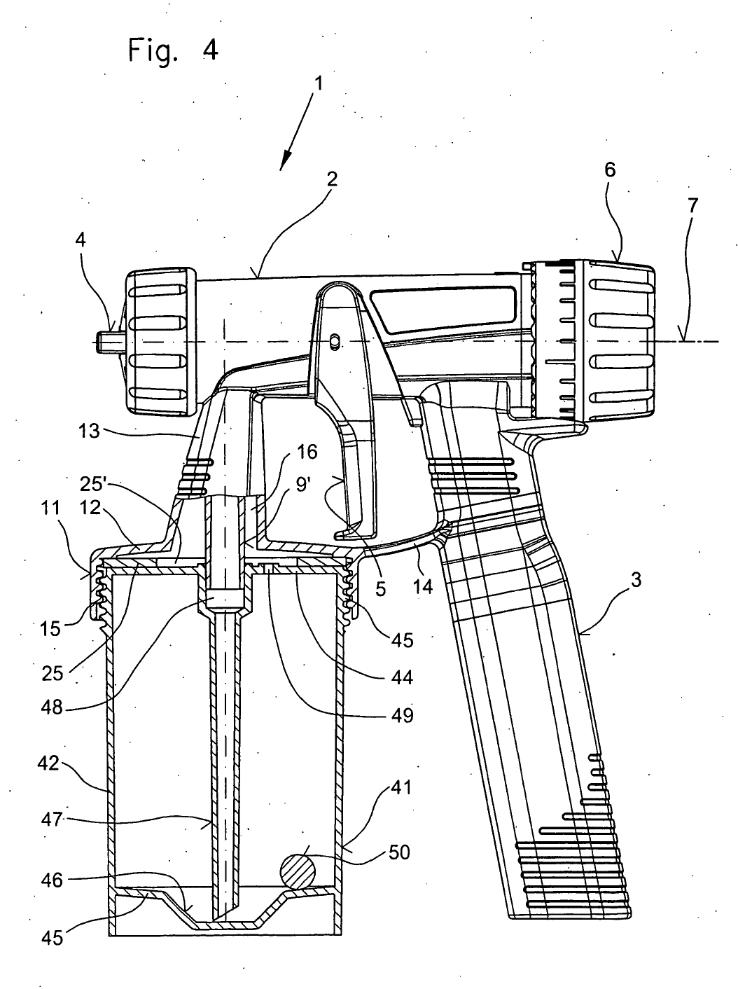

FIG. 4 shows the spray gun in accordance with FIG. 1 with a screwed-on storage container provided with a riser pipe,

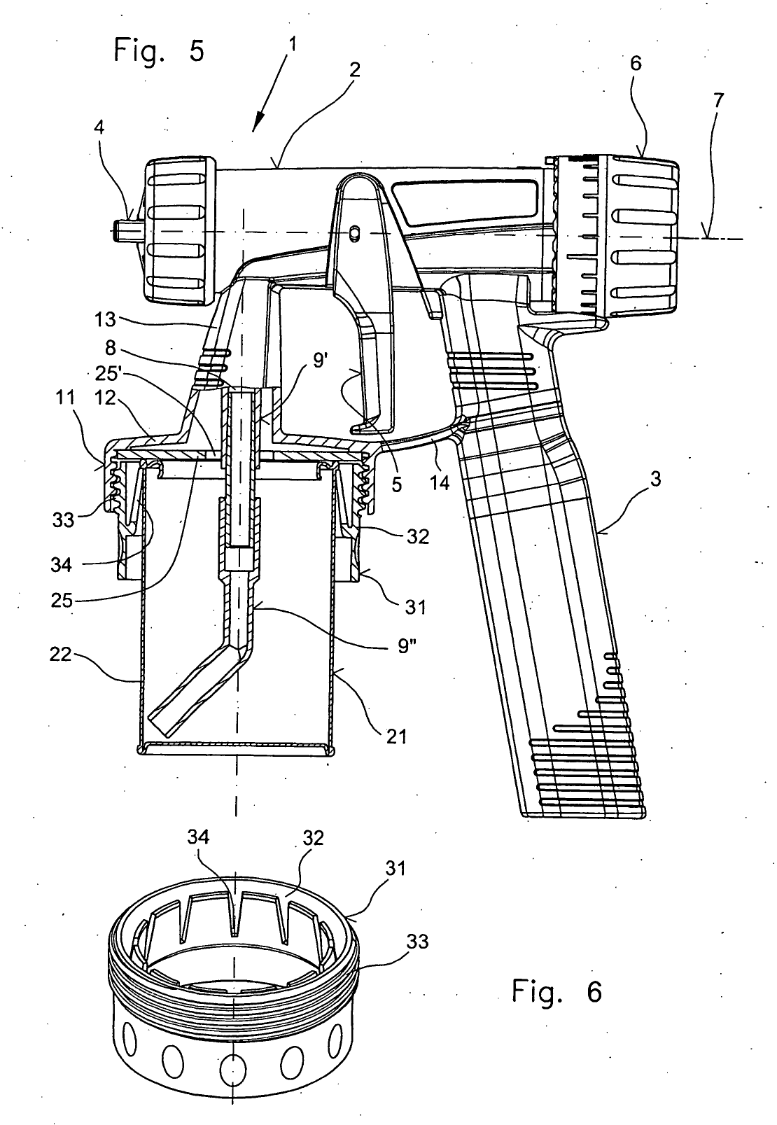

FIG. 5 shows the spray gun in accordance with FIG. 1 with a storage container attached by a clamping ring,

FIG. 6 shows the clamping ring in accordance with FIG. 5 in a perspective view,

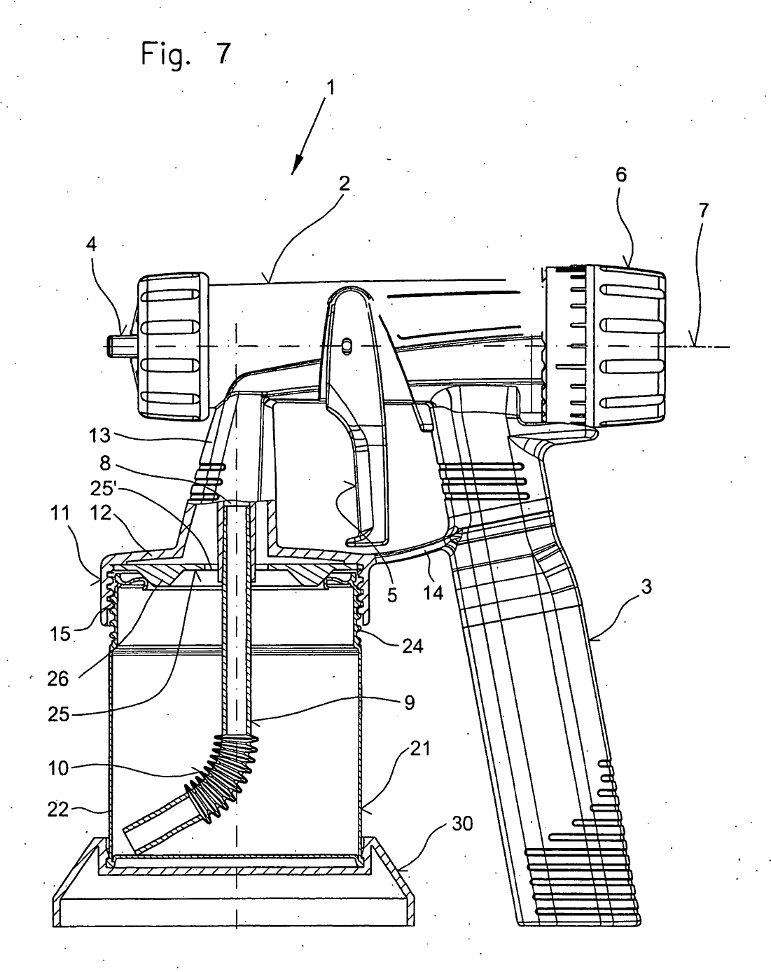

FIG. 7 shows the spray gun in accordance with FIG. 1 with a screwed-on storage container provided with a leg,

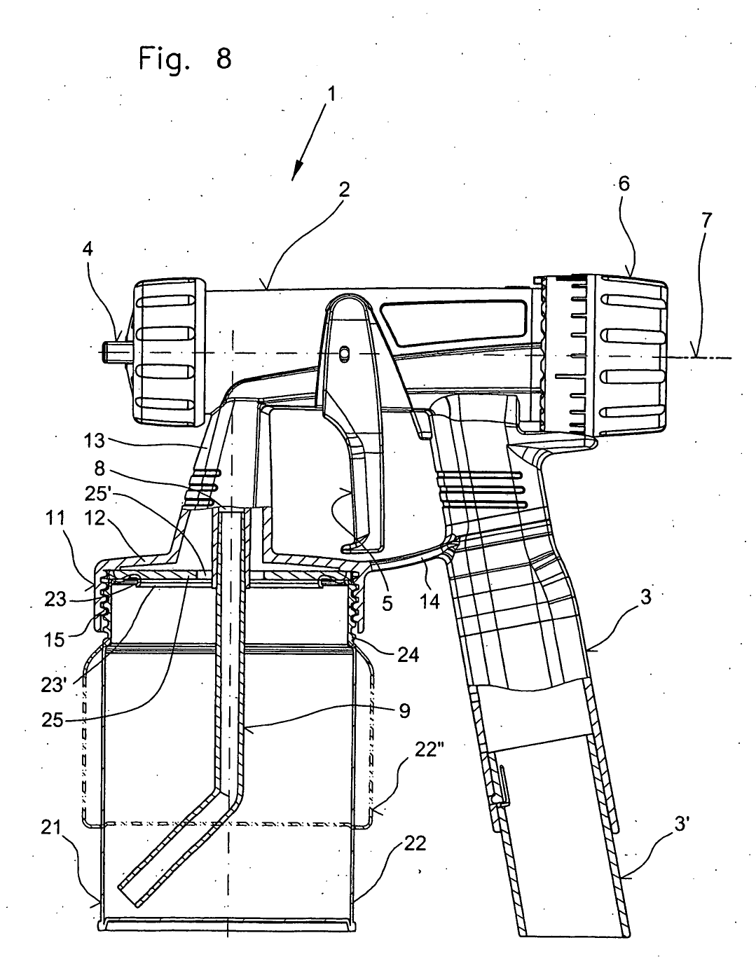

FIG. 8 shows the spray gun in accordance with FIG. 1 with a handle that is adjustable in length and differently configured, screwed-on storage containers,

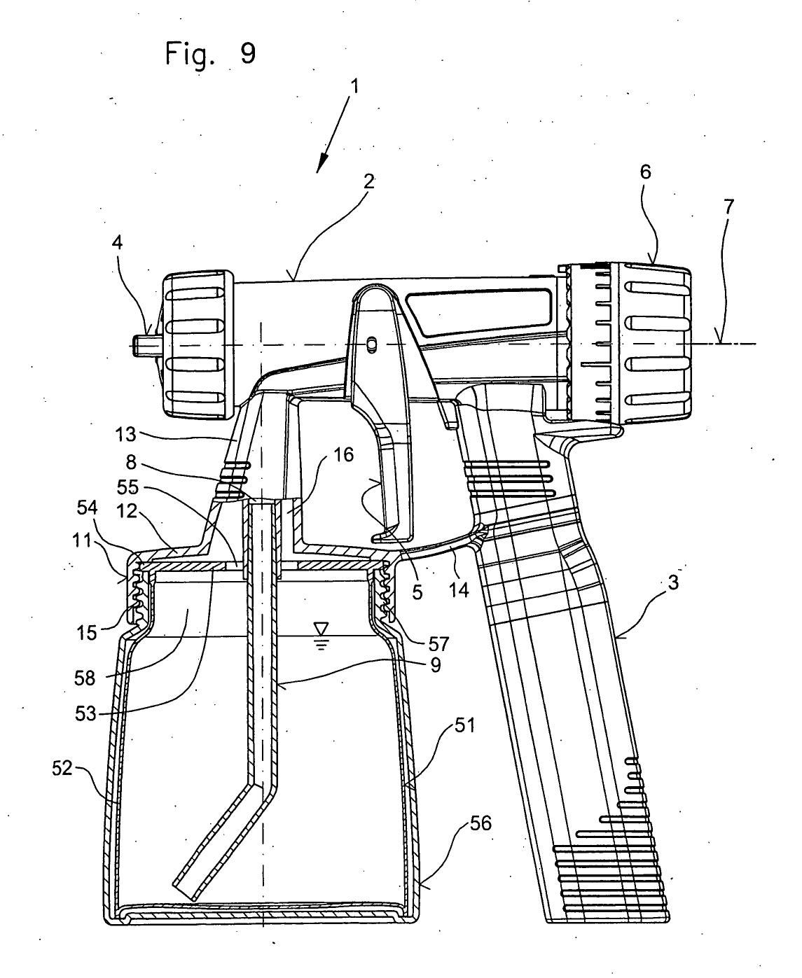

FIG. 9 shows the spray gun in accordance with FIG. 1 with a storage container configured as an elastic bag,

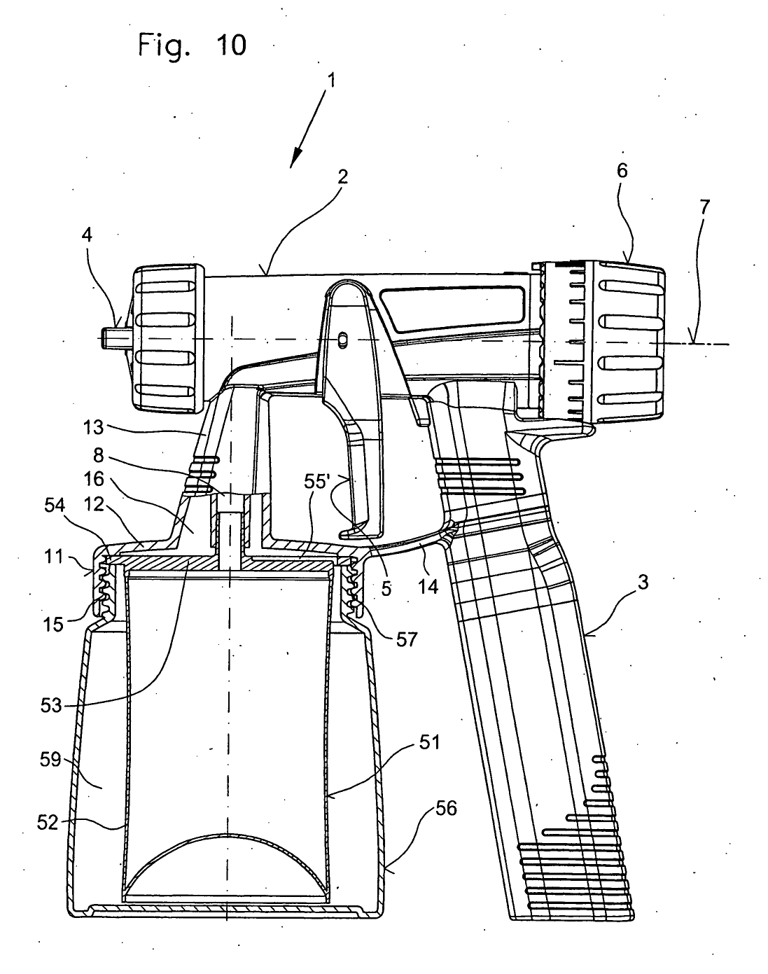

FIG. 10 shows the spray gun in accordance with FIG. 1 with a storage container that is also configured as a bag.

The spray gun shown in FIG. 1 and identified with 1 is used for spraying paints and similar viscous media and principally consists of a gun housing 2 for accommodating the components that are required for operating the spay gun 1, a handle 3 projecting from the gun housing 2 and a reservoir tank 21 for holding the medium to be processed. An actuating lever 5 in a swivelling mounting is provided in order to trigger a spraying operation which, when it is moved, ejects the medium sucked out of the reservoir tank 21 mixed with air out of a nozzle 4 by means of compressed air supplied via a pressure line 7. An adjusting nut 6 enables the intensity of the spray jet ejected from the nozzle 4 to be adjusted. The actuating lever 5 also enables different types of propulsion systems for the spray gun 1 to be operated, for example switching on an electrical swivelling armature pump or a blower.

The reservoir tank 21 arranged on the underside of the gun housing 2 at the level of the handle 3 in the illustrated embodiment can, however, also be arranged above and attached to the gun housing 2 so that the medium to be sprayed is supplied to the spray gun 1 by gravity. The tank 21 comprises a storage container adapted and adjusted to the spray gun 1 in the form of a paint can 22 attached directly to the gun housing 2 of the spray gun. To make this possible, a projection 11 is formed onto the gun housing 2 that is configured as a U-shaped cover 12 and is held onto the gun housing 2 or handle 3 by means of two webs 12 and 14. A female thread 15 is worked into the projection 11 and the paint can 22 is provided with a male thread 24 in the area of the can facing the can opening 23′, so that the can 22 can be securely attached to the projection 11 directly.

When the opened can 22 is screwed in, a riser pipe 9 projecting from the projection 11 is introduced into the opening 23′ after a cap 23 has been removed, by means of which opening 23′ the medium to be processed is sucked into a duct 8 by the air lo flowing into the gun housing 2, this channel 8 emerging in the inside of the gun housing 2. The paint can 22 filled with a medium prepared in an appropriate manner can therefore easily be attached to the projection 11. A seal 25 inserted between the projection 11 and the cap 23 of the paint can 22, having an opening 25′ for the riser pipe 9, thereby guarantees that the paint can 22 is connected to the spray gun 1 with a liquid-tight seal.

In the sample embodiment shown in FIG. 2, the reservoir tank 21′ that is also configured as a paint can 27 is attached to the projection 11 by means of a clamping element 31 that is configured as a clamping ring 32. The clamping ring 32 is provided with a male thread 33 for this purpose and acts on a radially projecting collar 28 of the paint can 27 so that the paint can 27 is pressed against the seal 25 inserted into the projection 11 by virtue of the fact that the clamping ring 32 is screwed onto the projection 11.

In accordance with FIG. 3, the clamping ring 32 of the clamping element 3 is provided with a hollow body 35 into which the reservoir tank 21′ is inserted. The hollow body 35 in this case is adapted to the handle 3 of the spray gun 1 so that their support surfaces run in one plane. The spray gun 1 can therefore be put down securely.

In the sample embodiment shown in FIG. 4, a reservoir tank 41 in the form of a closed paint can 42 is attached to the projection 42. For this purpose, the paint can 42 is equipped with a male thread 45 in the area of the formed cap 44 and this male thread 45 is screwed into the female thread 15 of the projection. In addition, the cap 44 of the paint can 42 has a centrally arranged opening 48 that is sealed during transport, for example by a plastic foil, and is penetrated by a riser pipe 9′ projecting from the projection 11 when the paint can 42 is connected. When the paint can 42 is attached, the interacting threads 15 and 45 press it against the seal 25.

The paint can 45 is additionally provided with a riser pipe 47 as an extension of the opening 48, this riser pipe 47 projecting into a recess 46 formed into the base 45 of the paint can 42. In addition, mixing bodies 50 are inserted into the paint can 42 by means of which the medium in the paint can 42 can be mixed by shaking the paint can 42 before it is screwed onto the projection 11.

The supply of medium to be processed from the paint can 22 is assisted by the compressed air pressure that is applied to the medium. This is because compressed air can enter the paint can 42 by means of a duct 16 worked into the web 13, a process which involves the compressed air passing into the inside of the paint can 42 through the opening 25′ in the seal 25 and through one or more penetrations 49 worked into the cap 44. The pressurisation of the medium in the paint can 42 means that the medium is forced into the riser pipe 9′ and, through this, into the gun housing 2.

To enable paint cans with diameters that are not adapted to the projection 11 to be clamped onto it nevertheless, as shown in FIGS. 5 and 6, the clamping element 31 configured as a clamping ring 32 is equipped with spring-loaded clamping arms 34 projecting radially inwards that act on the knurled edge area of the paint can 22. The clamping arms 34 can deflect outwards depending on the diameter of the paint can 22 whilst, nevertheless, the paint can 22 is always clamped on securely by the clamping ring 32 that has a male thread 33 and is screwed into the projection 11.

In the sample embodiment shown in FIG. 7, the paint can 22 provided as a reservoir tank 21 has a leg 30 that extends vertically in a manner that is adapted to the paint can 22. In this way, the support surfaces of the spray gun 1 in the area of the reservoir tank 21 and of the handle 3 run in the same plane. In addition, the riser pipe 9 is equipped with an elastically deformable intermediate piece 10 so that the riser pipe 9 can also be adapted to the size of whichever spray can 22 is screwed on.

Furthermore, as shown in FIG. 7, the seal 25 can be provided with sealing lips 26 that make contact on the inside with the opening 23′ in the cap 23 of the paint can 22. In this way, a reliable seal is guaranteed.

In order to ensure that the spray gun 1 will stand securely even with paint cans 22 and 22′ of differing heights, the sample embodiment shown in FIG. 8 has the handle 3 of the spray gun 1 provided with an insert 3′ that can be locked on the handle 3 in different height positions in accordance with the height of the drawn paint cans 22 and 22′, e.g. with the help of a spring detent.

In accordance with the depictions in FIGS. 9 and 10, an elastically deformable paint bag 52 is provided as the reservoir tank 51. The top end of the paint bag 52 is equipped with a flat, rigid flange 53 made from metal or plastic, with radially projecting edges 54.

The paint bag 52 is secured to the projection 11 by means of a pot-shaped container 56 that is provided with a male thread 57. Screwing the container 56 into the projection 11 causes the flange 53 of the paint bag 52 to be clamped and pressed against the projection 11.

To supply the medium contained in the paint bag 52 to the spray gun 1, the medium stored in the paint bag 52 is pressurised by compressed air in accordance with FIG. 9. The compressed airs flows from the gun housing 2 into the interior 58 of the paint bag 52 through a duct 16 provided in the web 13 and a passage opening 55 worked into the flange 53. In the sample embodiment shown in FIG. 10, on the other hand, the space 59 between the container 56 and the paint bag 52 is pressurised by compressed air that is able to enter the space 59 through a duct 55′ formed in the flange 53. The pressure applied to the medium in the paint bag 52 or to the bag 52 itself means that the medium is forced into the gun housing 2 and can then be processed by means of the spray gun 1.

1. A spray gun (1) for spraying paints and viscous media that can be propelled pneumatically or electrically, the spray gun comprising;
a gun housing (2) for accommodating a propulsion mechanism, comprising components of the spray gun (1) that effect at least one of mixture and metering;
a handle (3) projecting from said gun housing (2); and
a reservoir tank (21) removably attached to said gun housing (2) for holding the medium to be processed, and
means for introducing the medium from said reservoir tank (21) into said gun housing (2) of the spray gun (1) via a feed duct (8) that is provided with a riser pipe (9); wherein
said reservoir tank (21, 21′, 41, 51) comprises a storage container (22, 27, 42, 52); said storage container being attached to a selected one of (1) a projection (11) comprising a selected one of (1) a cover (12) and plate that is connected to said gun housing (2) by a web (13) and (2) to said handle (3) by a web (14), and (3) attached to the projection (11) by means of clamping elements (31) supported against the projection (11).

2. The spray gun in accordance with claim 1, wherein said storage container (22, 42) is configured in the form of a metallic can that can be screwed directly into a female thread (15) provided in the projection (11) by means of a male thread (24, 43) on an edge area of the can facing the a can opening (23, 48).

3. The spray gun in accordance with claim 1, wherein an end area of said storage container facing the projection (11) is provided with a radially projecting collar (28), the projection (11) has a female thread (15), and a clamping element (31) configured as a clamping ring (32), is provided for clamping said storage container onto the projection (11) by a selected one of pressing the clamping element (31) against the projection (11), and a seal (25) inserted therein, directly or by means of clamping arms (33) projecting radially inwardly and acting on the collar (28).

4. The spray gun in accordance with claim 3, wherein clamping element (31) provided for clamping said storage container (22) is configured as a hollow body (35) for accommodating said storage container (22).

5. The spray gun in accordance with claim 1, wherein said storage container (42) is provided with a riser pipe (47) arranged centrally and inserted in a recess (46) formed in a base (45) of said storage container (42), the riser pipe (47) being directly formed onto a closing cap (44) of said storage container (42) and into which the riser pipe (9′) of the spray gun (1) can be inserted when said storage container is connected.

6. The spray gun in accordance with claim 5, wherein said storage container (42) is provided with at least one mixing body (50) disposed therein.

7. The spray gun in accordance with claim 1, wherein to compensate for differing heights of storage containers (22), clip-on legs (30) are provided, by means of which a support surface of said storage container (22) is adapted to a support surface of said handle (3).

8. The spray gun in accordance with claim 1, wherein the height of said storage container (22) can be adjusted to a support surface of said handle (3), or a position of said handle (3′, 3″) can be adjusted so that the support surfaces of said storage container (22″) and of said handle (3′, 3″) extend in a common plane.

9. The spray gun in accordance with claim 2, wherein said reservoir tank comprises a flexibly deformable paint bag (52) of an elastic synthetic material provided with a sturdy flat termination flange (53) at an end thereof facing the projection (11) of said gun housing, and said paint bag (52) is inserted in a support element (56) that can be screwed into the female thread (15) provided in the projection (11) by means of a male thread (57) provided in an upper end area of the support element (56), by clamping a projecting edge (54) of the terminating flange (53) in between the support element (56) and the projection (11).

10. The spray gun in accordance with claim 9, wherein in a the spray gun (1) actuated pneumatically, a selected one of (1) the interior (58) of said paint bag (52) and (2) a space (49) between the support element (56) and said paint bag (52), is connected by ducts (16, 55′) to an air guidance duct in said gun housing (2) of the spray gun (1).

11. The spray gun in accordance with claim 1, wherein the length of the riser pipe (9) can be adapted to the height of said storage container (22) by means of a selected one of (1) projections (9″) and intermediate pieces (10).

12. The spray gun in accordance with claim 1, wherein each storage container (22) is supported on the projection (11) by a plate-shaped seal (25).

13. The spray gun in accordance with claim 12, wherein the seal (25) is provided with at least one circumferential sealing lip (26) protruding in the direction of said storage container (22) and makes contact internally against an edge of the opening (23′) of said storage container (22).
